(19) United States
(12) Patent Application Publication
(10) Pub. No.: US 2018/0142735 A1
(43) Pub. Date: May 24, 2018

(54) COMPOSITE FLANGE FOR A VEHICLE

(71) Applicant: GM Global Technology Operations LLC, Detroit, MI (US)

(72) Inventors: John H. Rode, Swartz Creek, MI (US); Eric R. Doak, Grand Blanc, MI (US); Ronald G. Mattise, Davisburg, MI (US)

(21) Appl. No.: 15/355,365

(22) Filed: Nov. 18, 2016

(51) Int. Cl. F16D 1/033; F16D 1/076

(52) U.S. Cl. CPC F16D 1/033; F16D 1/076

(57) ABSTRACT

A multi-piece flange includes a hub portion formed from a first material. The hub portion includes a central opening. A disc portion is formed from a second material that is lighter than the first material. The disc portion includes hub receiving portion configured to receive the hub portion.

### FIELD OF THE INVENTION

The subject invention relates to the art of vehicles and, more particularly, to a composite flange for a vehicle.

### BACKGROUND

Vehicles include numerous components that may be joined by interfacing flanges. Flanges may be employed to join cooling components, exhaust components, intake components, and driveline components. Flanges may support vibrational loads associated with operating a vehicle. Driveline flanges may support torque loading that may pass through a driveline component. Flanges that support vibrational loading and torque loading may add undesirable weight to the vehicle that can detract from vehicle performance. Accordingly, it is desirable to provide flanges are lightweight and capable of supporting operating loads.

### SUMMARY OF THE INVENTION

In accordance with an exemplary embodiment, a multi-piece flange includes a hub portion formed from a first material. The hub portion includes a central opening. A disc portion is formed from a second material that is lighter than the first material. The disc portion includes hub receiving portion configured to receive the hub portion.

In accordance with another aspect of an exemplary embodiment, a vehicle includes a chassis, a body supported by the chassis, and a drive system including at least one driveline component supported by the chassis. The at least one driveline component includes a multi-piece flange having a hub portion formed from a first material. The hub portion includes a central opening. A disc portion is formed from a second material that is lighter than the first material. The disc portion includes hub receiving portion configured to receive the hub portion.

In accordance with another aspect of an exemplary embodiment a method of forming a driveline flange for a vehicle includes installing a hub portion formed from a first material into a hub receiving portion of a disc portion formed from a second material that is lighter than the first material.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 depicts a schematic view of a vehicle including a composite flange, in accordance with an exemplary embodiment;

FIG. 2 depicts a perspective view of a first side of a composite flange, in accordance with an exemplary embodiment;

FIG. 3 depicts a perspective view of a second side of the composite flange of FIG. 2;

FIG. 4 depicts a perspective view of a first side of a disc portion of the composite flange of FIG. 2, in accordance with an exemplary embodiment;

FIG. 5 depicts a perspective view of a second side of the disc portion of

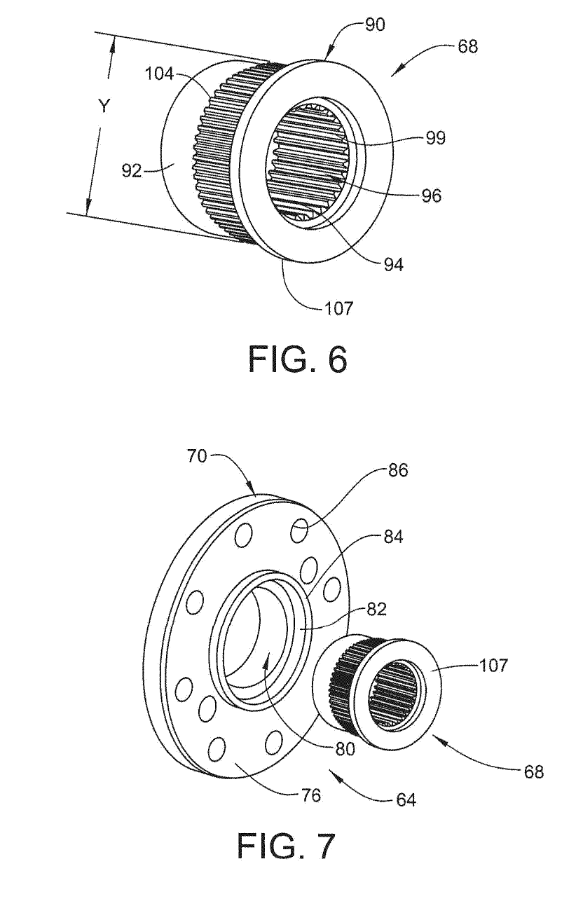

FIG. 4;

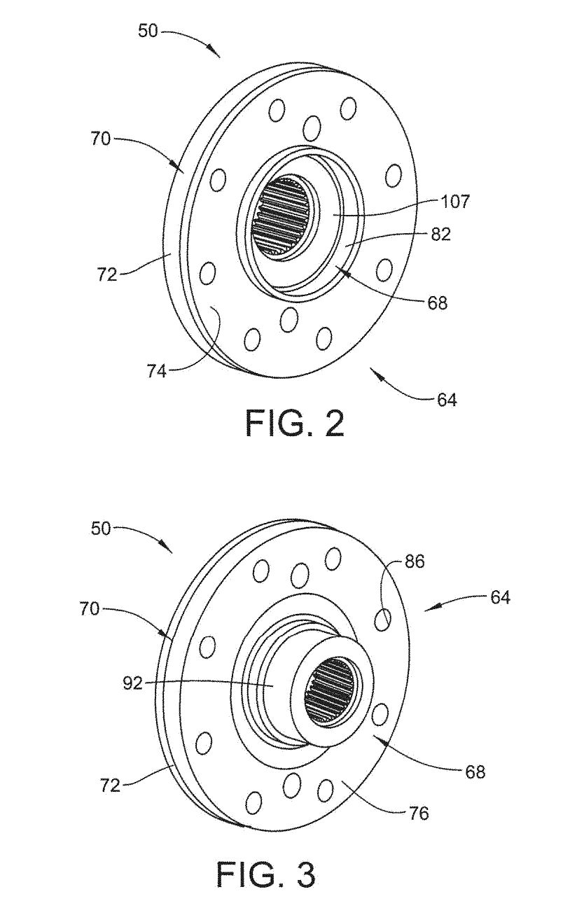

FIG. 6 depicts a perspective view of a hub portion of the composite flange of FIG. 2;

FIG. 7 depicts a disassembled view of the composite flange of FIG. 2;

FIG. 8 depicts a perspective view of a disc portion, in accordance with another aspect of an exemplary embodiment; and

FIG. 9 depicts a perspective view of a hub portion, in accordance with another aspect of an exemplary embodiment.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

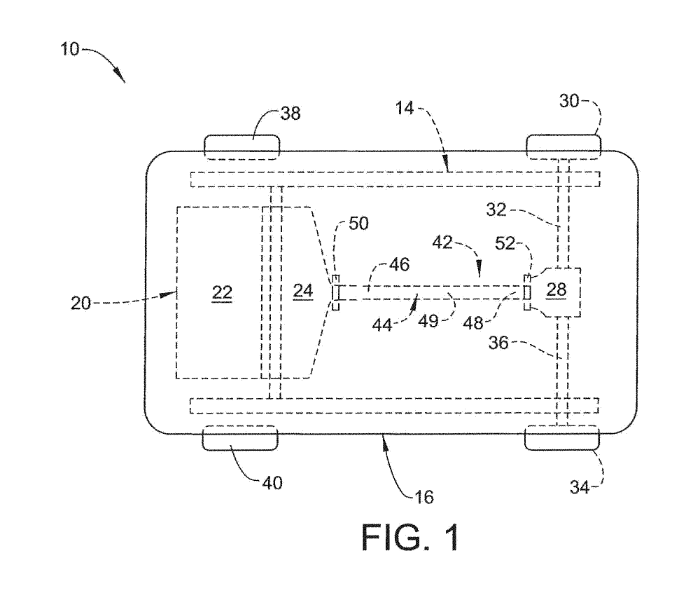

A vehicle, in accordance with an exemplary embodiment, is indicated generally at 10 in FIG. 1. Vehicle 10 includes a chassis 14 supporting a body 16. Chassis 14 also supports a drive system 20 including a motor 22, a transmission 24 and a rear differential 28. It is to be understood that motor 22 may take the form of an electric motor, an internal combustion engine, a hybrid electric motor or other forms of prime movers that provide motive power to vehicle 10. Rear differential 28 is coupled to a first rear wheel 30 through a first axle 32 and to a second rear wheel 34 through a second axle 36. Vehicle 10 may also include first and second front wheels 38 and 40. It is also to be understood that while shown as having a rear wheel drive, other drive configurations including front wheel drive and four wheel drive may also be employed.

In accordance with an aspect of an exemplary embodiment, vehicle 10 includes a number of driveline components 42, one of which may take the form of a driveshaft 44 operatively connecting transmission 24 and rear differential 28. Driveshaft 44 includes a first end 46, a second end 48 and an intermediate portion 49 extending therebetween. Transmission 24 includes a multi-piece flange 50 that interfaces with first end 46 of driveshaft 44. Rear differential 28 may include a multi-piece flange 52 that interfaces with second end 48 of driveshaft 44.

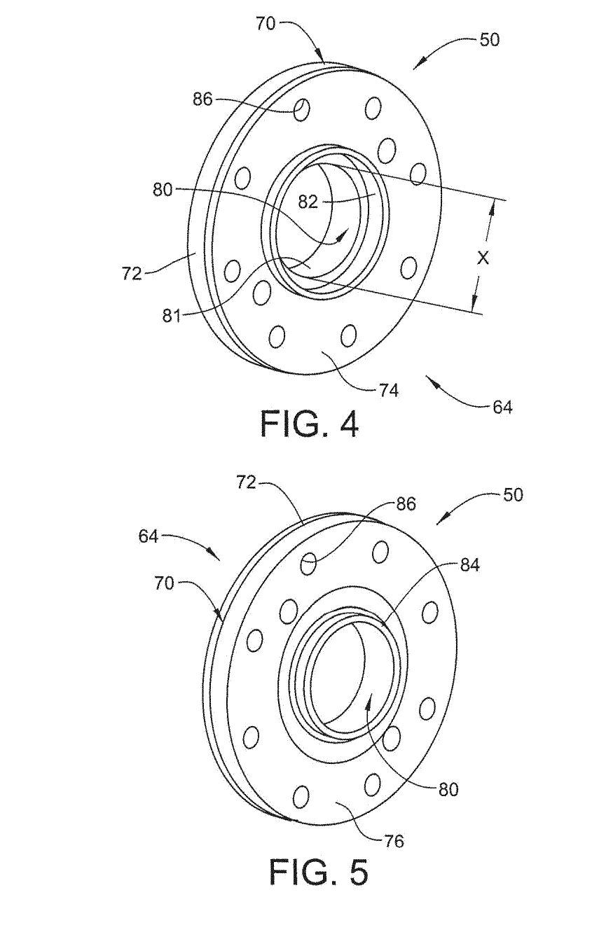

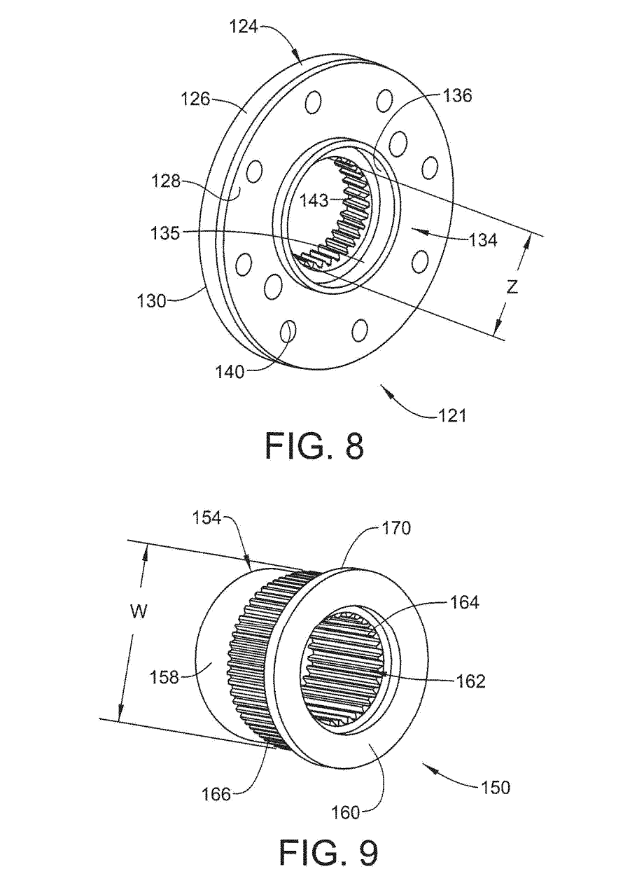

Reference will now follow to FIGS. 2-7 in describing multi-piece flange 50 with an understanding that multi-piece flange 52 may include similar structure. Multi-piece flange 50 includes a disc portion 64 formed from a first material and a hub portion 68 formed from a second material that is heavier than the first material. That is, multi-piece flange 50 comprises a composite or hybrid flange. In accordance with an aspect of an exemplary embodiment, the first material may comprise aluminum and/or alloys thereof and the second material may comprise steel and/or alloys thereof. It is to be understood that aluminum and steel are but two examples that may be employed as first and second materials.

Disc portion 64 incudes a body 70 having an outer annular edge 72, a first surface 74 and a second surface 76. A hub receiving portion 80 extends through first surface 74 and second surface 76. Hub receiving portion 80 includes an inner annular surface 81 defining a first dimension “X” and is arranged centrally on body 70. An annular recess 82 extends about hub receiving portion 80 axially into first surface 74 and an annular projection 84 extends about hub receiving portion 80 axially outwardly of second surface 76. A plurality of openings 86 are formed in body 70. Openings 86 may receive mechanical fasteners (not shown) that connect multi-piece flange 50 to, for example, transmission 24.

Hub portion 68, in FIG. 7, includes a body portion 90 having an outer annular surface 92 defining a second dimension “Y” that is greater than first dimension “X”. Thus, hub portion 68 may be installed into hub receiving portion 80 with an interference fit. Hub portion 68 also includes an inner annular surface 94 that defines a central opening 96. Central opening 96 may be provided with a plurality of splines 99 that interface with another plurality of splines (not shown) on first end 46 of driveshaft 44. Outer annular surface 92 may be provided with a plurality of raised ribs 104 that may deform when hub portion 68 is installed into hub receiving portion 80 to enhance a mechanical bond therebetween. Hub portion 68 may also include a flange 107 that nests within annular recess 82 when hub portion 68 is mounted to disc portion 64.

Reference will now follow to FIG. 8 in describing a disc portion 121 in accordance with another aspect of an exemplary embodiment. Disc portion 121 includes a body 124 having an outer annular edge 126, a first surface 128 and a second surface 130. A hub receiving portion 134 extends through first surface 128 and second surface 130. Hub receiving portion 134 includes an inner annular surface 135 defining a first dimension “Z” and is arranged centrally in body 124. An annular recess 136 extends about hub receiving portion 134 axially into first surface 128 and an annular projection (not shown)may extend about hub receiving portion 134 axially outwardly of second surface 130. A plurality of openings 140 are formed in body 124. Openings 140 may receive mechanical fasteners (not shown) that connect multi-piece flange 50 to, for example, transmission 24. In the exemplary aspect shown, inner annular surface 135 includes a plurality of splines 143.

A hub portion 150, as shown in FIG. 9, includes a body portion 154 having an outer annular surface 158 defining a second dimension “W” that is less than first dimension “X”. Hub portion 68 also includes an inner annular surface 160 that defines a central opening 162. Central opening 162 may be provided with a plurality of splines 164 that interface with another plurality of splines (not shown) on first end 46 of driveshaft 44. Outer annular surface 158, in the exemplary aspect shown, are provided with a plurality of splines 166 that interact or engage with splines 143 on inner annular surface 135 of hub receiving portion 134. Hub portion 150 may also include a flange 170 that nests within annular recess 136 when hub portion 150 is mounted to disc portion 121.

At this point it should be understood that the exemplary embodiments describe a flange formed from multiple materials that meets both weight reduction and force transmission goals. That is, the hub portion is formed from a material that supports torque loading while the disc portion may be formed from a lighter weight material. Those materials may vary and may be dependent upon particular applications. Further, while described as being employed with a driveline component, it is to be understood that the exemplary embodiments may be employed in other systems in which weight reduction and torque transmission are of interest.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A multi-piece flange comprising:
a hub portion formed from a first material, the hub portion including a central opening; and
a disc portion formed from a second material that is lighter than the first material, the disc portion including hub receiving portion configured to receive the hub portion.

2. The multi-piece flange according to claim 1, wherein the hub portion includes an outer annular surface and an inner annular surface defining the central opening, the inner annular surface including a plurality of splines.

3. The multi-piece flange according to claim 1, wherein the hub portion includes an outer annular surface having a first dimension and the hub receiving portion includes an inner annular surface portion having a second dimension that is less than the first dimension establishing an interference fit with the hub portion.

4. The multi-piece flange according to claim 1, wherein the hub portion includes an outer annular surface including a first plurality of splines and the hub receiving portion includes an inner annular surface portion having a second plurality of splines that engage with the first plurality of splines.

5. The multi-piece flange according to claim 1, wherein the first material comprises steel and the second material comprises aluminum.

6. The multi-piece flange according to claim 1, wherein the disc portion includes an annular recess extending about the hub receiving portion and the hub portion includes a flange section configured to nest within the annular recess.

7. A vehicle comprising:
a chassis;
a body supported by the chassis; and
a drive system including at least one driveline component supported by the chassis, the at least one driveline component including a multi-piece flange comprising:
a hub portion formed from a first material, the hub portion including a central opening; and
a disc portion formed from a second material that is lighter than the first material, the disc portion including hub receiving portion configured to receive the hub portion.

8. The vehicle according to claim 7, wherein the hub portion includes an outer annular surface and an inner annular surface defining the central opening, the inner annular surface including a plurality of splines.

9. The vehicle according to claim 7, wherein the hub portion includes an outer annular surface having a first dimension and the hub receiving portion includes an inner annular surface portion having a second dimension that is less than the first dimension establishing an interference fit with the hub portion.

10. The vehicle according to claim 7, the hub portion includes an outer annular surface including a first plurality of splines and the hub receiving portion includes an inner annular surface portion having a second plurality of splines that engage with the first plurality of splines.

11. The vehicle according to claim 7, wherein the first material comprises steel and the second material comprises aluminum.

12. The vehicle according to claim 7, wherein the disc portion includes an annular recess extending about the hub receiving portion and the hub portion includes a flange section configured to nest within the annular recess.

13. A method of forming a driveline flange for a vehicle, the method comprising:
installing a hub portion formed from a first material into a hub receiving portion of a disc portion formed from a second material that is lighter than the first material.

14. The method of claim 13, wherein installing the hub portion includes positioning the hub portion formed from steel in the hub receiving portion of the disc portion formed from aluminum.

15. The method of claim 13, wherein installing the hub portion includes press-fitting the hub portion into the hub receiving portion.

16. The method of claim 13, wherein installing the hub portion includes engaging a first plurality of splines on an outer annular surface of the hub portion with a second plurality of splines formed on an inner annular surface portion of the hub receiving portion.

17. The method of claim 13, further comprising: forming a plurality of splines on an inner annual surface of the hub portion.
